(19) United States
(12) Patent Application Publication
(10) Pub. No.: US 2009/0275237 A1
(43) Pub. Date: Nov. 5, 2009

(54) SIM Card Connector

(75) Inventor: Shu-Man Chiang, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/114,791

(22) Filed: May 4, 2008

(51) Int. Cl. H01R 24/00

(52) U.S. Cl. 439/629

(57) ABSTRACT

A SIM card connector includes a dielectric housing and a plurality of electric terminals. The dielectric housing has a base, a plurality of receiving grooves is opened in the base, a receiving space is formed above the base for receiving a SIM card. The electric terminal secured to the dielectric housing has a fixing portion fixed to the base of the dielectric housing, an elastic portion bending upward from the fixing portion and extending into the corresponding receiving groove, and a contacting portion continuously extending from the elastic portion and protruding into the receiving space to electrically the SIM card. A curving portion is curved downward from the contacting portion, and a connecting portion extends continuously from the curving portion and is fixed to the base.

### BACKGROUND OF THE INVENTION

1. Field of the Invention

This present invention relates to a card connector, and more specifically to a SIM card connector.

2. The Related Art

An electric terminal 40 of a traditional SIM card connector is shown in FIG. 1. The electric terminal 40 has a fixing portion 41 showing an oblong board shape, and two clicking portions 42 extended outward and bent upward from a left side and a right side of the fixing portion 41. A front end of the fixing portion 41 curves downward and then extends forward to form a welding portion 43. A middle of the fixing portion 41 defines an opening 44 penetrating the left side thereof and located between the two clicking portions 42 extended from the left side. A rear of the fixing portion 41 extends forward and bends upward to form an elastic portion 45 above the opening 44, a free end of the elastic portion 45 extends to form a connecting portion 46, an upper surface of the connecting portion 46 projects upward to form a connecting tip 47. When a SIM card slips into the traditional SIM card connector, the connecting tips 47 resist terminals formed in the SIM card to transmit electric signal.

When the SIM card is pulled out from the traditional SIM card connector, the SIM card pushes the connecting portion 46, the elastic portion 45 will curve around the fixing portion 41, so the electric terminal 40 is easy to be curved and destroyed.

### SUMMARY OF THE INVENTION

An object of the invention is to provide a SIM card connector including a dielectric housing, a cover and a plurality electric terminals. The dielectric housing has a base, a plurality of receiving grooves is opened in the base, a receiving space is formed above the base for receiving a SIM card. The electric terminal secured to the dielectric housing has a fixing portion fixed to the base of the dielectric housing, an elastic portion bending upward from the fixing portion and extending into the corresponding receiving groove, and a contacting portion continuously extending from the elastic portion and protruding into the receiving space to electrically the SIM card. A curving portion is curved downward from the contacting portion, and a connecting portion extends continuously from the curving portion and is fixed to the base.

As described above, the electric terminals are fixed in the dielectric housing, so the electric terminals are not damaged while the SIM card is pulled out from the SIM card connector.

### BRIEF DESCRIPTION OF THE DRAWINGS

The invention, together with its objects and the advantages thereof may be best understood by reference to the following description taken in conjunction with the accompanying drawings, in which:

FIG. 1 is a perspective view of an electric terminal of a traditional SIM card connector;

FIG. 2 is an exploded perspective view of a SIM card connector according to the present invention;

FIG. 3 is an assembled perspective view of a dielectric housing and a plurality of terminals of the SIM card connector;

FIG. 4 is a perspective view showing a first electric terminal of the SIM card connector;

FIG. 5 is a perspective view of a second electric terminal of the SIM card connector;

FIG. 6 is a cross-sectional view of the SIM card connector; and

FIG. 7 is a perspective view showing a SIM card inserted into the SIM card connector, in order to showing the connection between the SIM card and the SIM card connector, a hole is opened in the SIM card to show the terminal of the SIM card connector.

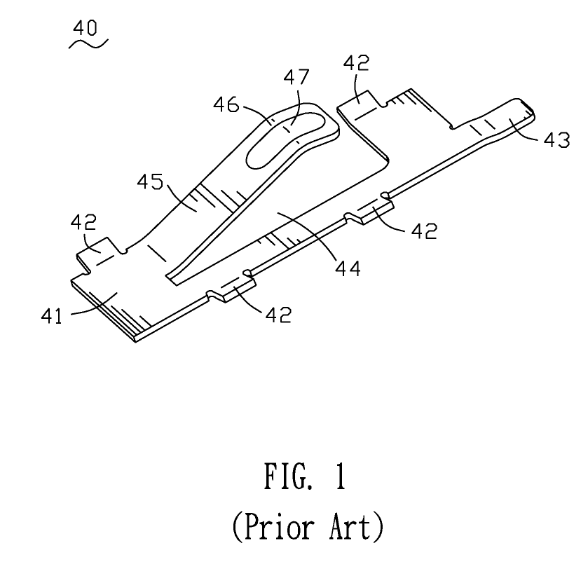

### DETAILED DESCRIPTION OF THE PREFERRED EMBODIMENT

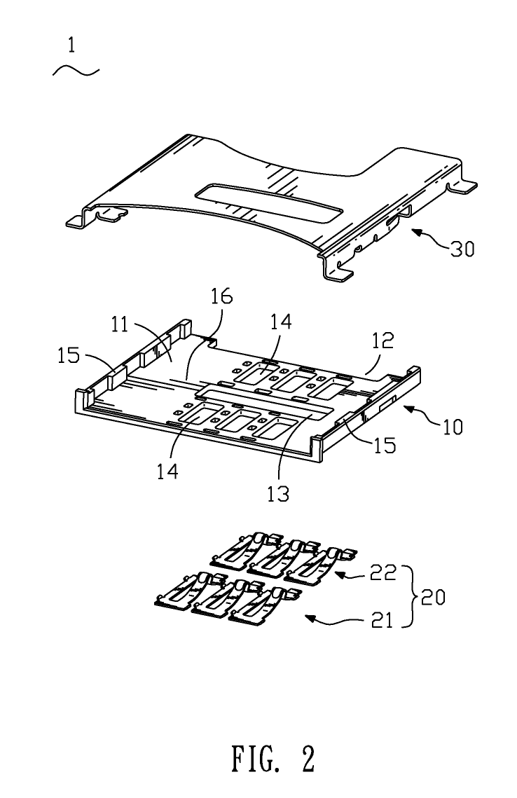

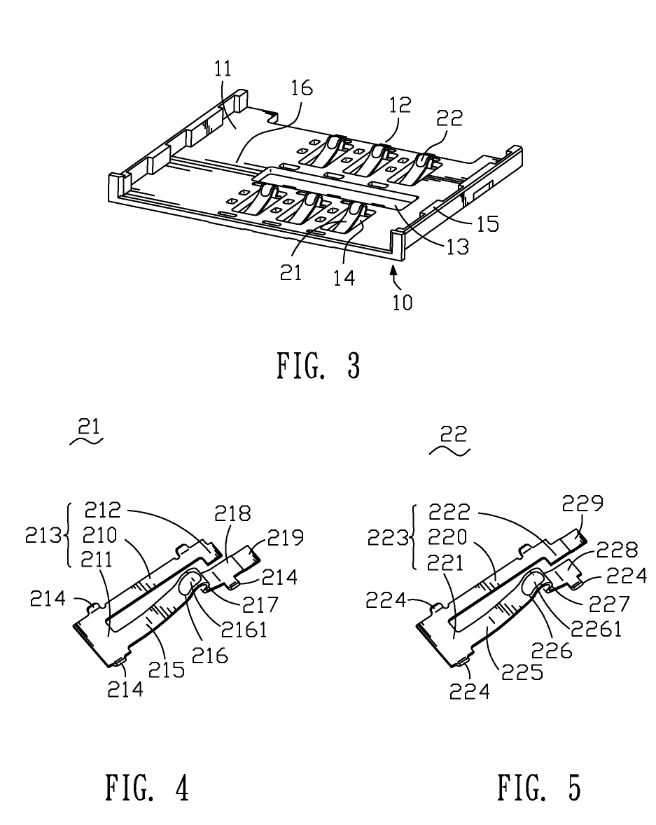

First referring to FIGS. 2 and 3, a SIM card connector 1 according to the invention is shown. The SIM card connector 1 includes a dielectric housing 10, a plurality of electric terminals 20 and a cover 30. Furthermore, the electric terminals 20 are formed in the dielectric housing 10 by insert molding. The cover 30 covers the dielectric housing 10.

In FIG. 2, the dielectric housing 10 has a base 11 showing a rectangular board shape, and two side walls 15 extended from two sides of the base 11 vertically. The base 11 and the side walls 15 define a receiving space 16 which is used to receive a SIM card 5 (shown in FIG. 7). A front end of the base 11 is cut to form a first welding groove 12. A middle of the base 11 is opened widthways to form a second welding groove 13. Two rows of receiving grooves 14 are opened in the base 11 and located at two sides of the second welding groove 13 respectively.

Please referring to FIGS. 2, 4 and 5, the electric terminals 20 are composed by a plurality of first terminals 21 and second terminals 22. The first terminal 21 has a fixing strip 210 showing an oblong shape, a first fixing slice 211 and a second fixing slice 212. The first fixing slice 211 extends rightward from a rear end of the fixing strip 210. The second fixing slice 212 extends rightward from a front end of the fixing strip 210. The first fixing slice 211 is longer than the second fixing slice 212. The fixing strip 210, the first fixing slice 211 and the second fixing slice 212 compose a fixing portion 213. A left side of the fixing strip 210 extends outward and bends upward to form two fixing slices 214. The first fixing slice 211 extends frontward and curves slantwise upward to form an elastic portion 215 spaced with the fixing strip 210. A free end of the elastic portion 215 extends upward and then bends downward to form a contacting portion 216. An upper surface of the contacting portion 216 projects upward to form a connecting tip 2161 showing a cambered surface shape. A free end of the contacting portion 216 extends downward to a curving portion 217 showing an S-shape. A free end of the curving portion 217 extends frontward to form a horizontal connecting portion 218 which parallels with the fixing strip 210. A front end of the connecting portion 218 extends to form a welding portion 219, a step is formed between the connecting portion 218 and the welding portion 219. Right sides of the first fixing slice 211 and the connecting portion 218 project outward and bend upward to form a fixing slice 214.

The shape of the second terminal 22 is similar with the shape of the first terminal 21. The second terminal 22 has a fixing strip 220, a first fixing slice 211, a second fixing slice 222, an elastic portion 225, a contacting portion 226, a curving portion 227, a connecting portion 228 and a fixing slice 224. The fixing strip 220, the first fixing slice 211 and the second fixing slice 222 compose a fixing portion 223. An upper surface of the contacting portion 226 projects upward to form a connecting tip 2261. The different between the first terminal 21 and the second terminal 22 is that a welding portion 229 is formed by the second fixing slice 222 extending frontward, and a step is formed between the welding portion 229 and the second fixing slice 222.

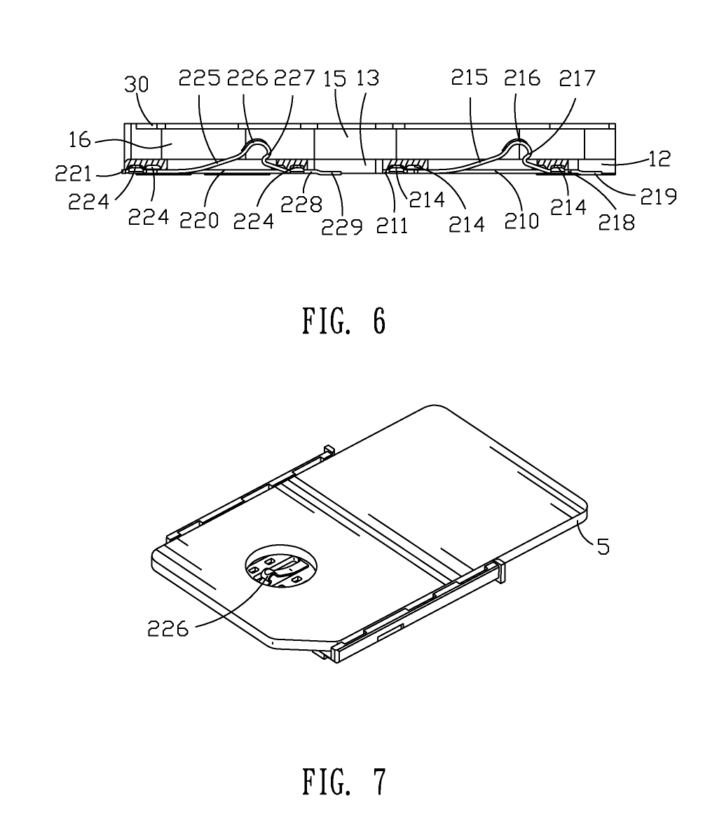

Please refer to FIGS. 4-6, the fixing portions 213, 223, the fixing slices 214, 224 and the connecting portions 218, 228 are integrally formed with the base 11, then the first terminal 21 and the second terminal 22 are fixed in the dielectric housing 10 as a unit. For the design of the fixing slices 214, 224, the electric terminals 20 are fixed with the dielectric housing 10 more firmly. The contacting portions 216, 226 project into the receiving space 16 via the receiving grooves 14 to connect the SIM card 5 while the SIM card 5 is inserted into the receiving space 16 of the SIM card connector 1. The welding portions 219, 229 downward project out from the first welding grooves 12 and the second welding grooves 13. And the welding portions 219, 229 are welded in a printed circuit board (PCB) (not shown) beneath the dielectric housing 10.

As described above, the fixing portions 213, 223, the fixing slices 214, 224, and the connecting portions 218, 228 are integrally formed with the base 11, so the electric terminals 20 are not damaged while the SIM card 5 is pulled out from the SIM card connector 1.

An embodiment of the present invention has been discussed in detail. However, this embodiment is merely a specific example for clarifying the technical contents of the present invention and the present invention is not to be construed in a restricted sense as limited to this specific example. Thus, the spirit and scope of the present invention are limited only by the appended claims.

What is claimed is:

1. A SIM card connector, comprising:
a dielectric housing having a base, a plurality of receiving grooves defined in the base, and a receiving space formed above the base for receiving a SIM card; and
a plurality of electric terminals secured to the dielectric housing, the electric terminals each having a fixing portion fixed to the base of the dielectric housing, an elastic portion bending upward from the fixing portion and extending into the corresponding receiving groove, a contacting portion extending continuously from the elastic portion and protruding into the receiving space to electrically connect the SIM card, a curving portion curved downward from the contacting portion to be elastically compressed into the corresponding receiving groove by the STM card, and a connecting portion with a monolithic conformation extending continuously from the curving portion and fixed to the base.

2. The SIM card connector as set forth in claim 1, wherein the fixing portion has a fixing strip showing an oblong shape and a fixing slice extending sideward from an end of the fixing strip, the elastic portion extends along the fixing strip from the fixing slice and is spaced from the fixing strip.

3. The SIM card connector as set forth in claim 2, wherein the fixing strip and the connecting portion are in a same plane.

4. The SIM card connector as set forth in claim 1, wherein an end of the connecting portion bends downward and then extends horizontally to form a welding portion.

5. The SIM card connector as set forth in claim 2, wherein an end of the fixing strip opposite the fixing slice bends downward and then extends horizontally to form a welding portion.

6. The SIM card connector as set forth in claim 1, wherein the curving portion shows an S-shape.

7. The SIM card connector as set forth in claim 1, wherein the dielectric housing is integrally formed with the electric terminals by insert molding.
